(19) United States
(12) Patent Application Publication
(10) Pub. No.: US 2014/0092240 A1
(43) Pub. Date: Apr. 3, 2014

(54) METHOD FOR DETERMINING ADJUSTMENT DEVIATIONS OF AN IMAGE DATA CAPTURE CHIP OF AN OPTICAL CAMERA, AS WELL AS CORRESPONDING ADJUSTMENT VERIFICATION DEVICES

(71) Applicants: Uwe Apel, Neckartailfingen (DE); Marzieh Asadeh Parchami, Leonberg (DE)

(72) Inventors: Uwe Apel, Neckartailfingen (DE); Marzieh Asadeh Parchami, Leonberg (DE)

(21) Appl. No.: 14/009,382

(22) PCT Filed: Feb. 9, 2012
(86) PCT No.: PCT/EP2012/052163

§ 371 Date: Dec. 6, 2013

(30) Foreign Application Priority Data
Apr. 7, 2011 (DE) 10 2011 006 910.0

(51) Int. Cl. H04N 5/232; H04N 7/18

(52) U.S. Cl. CPC H04N 5/23296; H04N 7/18
USPC 348/135

(57) ABSTRACT

A method, and an adjustment verification device, for determining adjustment deviations of an image data capture chip of an optical camera includes the steps of: aligning a laser beam of a laser source by an adjustment verification device to a camera image which is to be recorded by the optical camera and upon which a visible laser image is formed by the laser beam, the adjustment verification device including a camera holder for the positionally correct installation of the optical camera; recording the camera image by the positionally correctly installed optical camera; determining the coordinates of the laser image recorded in the camera image; and determining a deviation in the coordinates of the recorded laser image from a nominal position of the camera image and, on the basis thereof, deriving the adjustment deviations of the image data capture chip of the optical camera.

### CROSS REFERENCE TO RELATED APPLICATION

The present application is the national stage entry of International Patent Application No. PCT/EP2012/052163, filed on Feb. 9, 2012, which claims priority to Application No. DE 10 2011 006 910.0, filed in the Federal Republic of Germany on Apr. 7, 2011.

### FIELD OF INVENTION

The present invention relates to a method for determining adjustment deviations of an image data capture chip of an optical camera, as well as corresponding adjustment verification devices.

### BACKGROUND INFORMATION

German Patent Application No. DE 102 46 066 A1 describes a method for calibrating at least one image sensor system of a motor vehicle using at least one calibration object, the image sensor system generating a first piece of image information on the calibration object, preferably in the form of at least one image data record, and the alignment of the image sensor system relative to the driving axis of the motor vehicle being determined.

It is generally known that optical camera-based driver assistance systems, which monitor the near field of a vehicle, can assist the driver of the motor vehicle through functions such as lateral guidance and object detection, and enhance security.

An important performance feature required of such driver assistance systems for that purpose is the ability to correctly determine object coordinates in the three-dimensional world, such as lane markings and pedestrian positions, from the two-dimensional image data captured by the optical camera.

A further requirement of such driver assistance systems is that the optical camera's direction of view, as a bisector of the sensing cone, be brought into conformity with the vehicle's axis of travel as effectively as possible, since a skewed view reduces the optical camera's coverage, thereby limiting functioning.

Accordingly, the alignment verification, whereby the deviation in the camera's direction of view from the nominal direction of view is determined, is one of the most critical final optical tests.

To determine the capability of measuring devices, a measurement standard, thus a reference measure, is required for a quantity to be measured. A measurement standard for directly determining a camera's direction of view has not existed under known methods heretofore since it has been necessary in each case to determine the direction of view in relation to the fastening or mounting points of a camera. This means that a separate measurement standard would be needed for each housing shape and for each camera coverage determined from the lens data and image sensor data.

This objective has been achieved under known methods heretofore using testing technology, whereby the cameras are clamped in a test stand in which the test components are positioned in a known alignment relative to a test point field. The image of the test point field recorded in this clamped state is analyzed using a special image processing routine to determine the camera's direction of view and the lens distortion parameters. These data are then stored in the test component.

The alignment of the camera in the clamping configuration of the test stand is determined relative to the point coordinates on the test point field using two auxiliary steps from the field of measuring technology. In a first step, the points of engagement of the holder, on which the camera to be tested is positioned, are determined on a 3D coordinate measuring machine using measuring technology. In addition, the position of special reflector marks—Hubbs marks or reflectance spheres—is determined.

Using the CAD data of the camera to be tested as a basis, the position of the main point and the direction of view of the nominal optical camera are calculated from the coordinates of the points of engagement of the test component mount. Starting out from this point, the coordinates of the special reflector marks—Hubbs marks or reflectance spheres—are determined in the coordinate system of the test component. Building on this, the positions of the reference reflector marks on the test chart of the test stand are determined in a second step by photogrammetric measurement with reference to the coordinate system of the camera.

The results of the two measurements steps involving the test stand must be merged in a coordinate transformation in order to derive the parameter set for the image processing routines used in measuring the individual cameras. The result of the coordinate transformation calculation is used for calibration purposes. However, no calibration standard can be derived therefrom as the measured quantities are indirectly determined.

A camera that corresponds exactly to nominal design data cannot be manufactured due to the relatively substantial influences of the slightest mechanical deviations. For example, from the requirements that cameras for night vision applications have an angular resolution of 30 pixels (corresponding to 168 μm) per angular degree at a lens focal length of 10 mm, and that the maximum deviation from the nominal direction of view not exceed +/−1°.

It is thus discernible that even the slightest deviations, for instance in the placement of the image sensor on the conductor plate, contribute significantly to errors.

### SUMMARY

The present invention provides a method for determining deviations in the adjustment of an image-data capture chip of an optical camera, a laser beam from a laser source being aligned by an adjustment verification device to a camera image which is to be recorded by the optical camera and upon which a visible laser image is formed by the laser beam, the adjustment verification device having a camera holder for the positionally correct installation of the optical camera. In addition, the method also provides that the camera image be recorded by the positionally correctly installed optical camera. In addition, coordinates of the laser image recorded in the camera image are defined, and a deviation in the coordinates of the recorded laser image from a nominal position of the camera image is determined, and, on the basis thereof, deviations in the adjustment of the image data capture chip of the optical camera are derived.

The present invention provides an adjustment verification device for determining angular deviations of an optical camera, including a camera holder for a reference camera that has bearing elements for installing the reference camera in the camera holder and a bearing surface for a plane mirror, and a laser source that is configured in the adjustment verification device in a way that allows a laser beam to be adjusted on the plane mirror at one location of an optical axis of the adjustment verification device, and a reflected laser beam to be adjusted in coincidence with the laser beam.

The present invention provides an adjustment verification device for determining angular deviations of an optical camera, including a projection surface on which a line may be projected and for which an image may be formed by the optical camera, a laser source that is provided for projecting the line onto the projection surface that is disposed perpendicularly in front of the optical axis of the optical camera, and a rocker-type unit that is provided for the rotational mounting of the laser source.

The method and the adjustment verification device according to the present invention have an advantage of allowing a simplified design to be used to determine the positional angle of an optical camera in relation to an external suspension mount on the housing of the camera, for example.

This determination is made independently of the determination of other characteristic quantities, such as the intrinsic calibration parameters of the optical camera. It is likewise independent of the mechanical dimensions of the optical camera. It is merely necessary that they be known accurately enough.

In accordance with one preferred exemplary embodiment of the method, the following steps are carried out prior to alignment of the laser beam: making a reference camera ready for use which has bearing elements for installation of the same in the camera holder of the adjustment verification device and a bearing surface for a plane mirror, and which is used as part of the adjustment verification device; and equipping the bearing surface of the reference camera with the plane mirror and clamping the reference camera in the camera holder. An advantage in this context is that it enables the positional angles of an optical camera to be directly and readily determined in relation to an external suspension mount on the housing.

In accordance with another advantageous exemplary embodiment of the method, the laser beam is aligned in the testing device to strike the plane mirror at one location of an optical axis of the testing device, and a reflected laser beam is reflected in coincidence with the laser beam, the reference camera being replaced by the optical camera. The accuracy of the measurement is further improved by the alignment of the laser beam.

In accordance with another advantageous exemplary embodiment of the method, pitch and/or yaw deviations of the image data capture chip of the optical camera are determined as deviations in the adjustment of the image data capture chip.

In accordance with another advantageous exemplary embodiment of the method, a filter element is introduced into the ray path of the laser beam to avoid overexposure of the optical camera. The shape and size of the laser image and thus the accuracy of the measurement may be further improved by proper filtering using the filter element.

In accordance with another advantageous exemplary embodiment of the method, aperture elements are used for limiting the diameter of the laser beam when aligning the laser beam of the laser source in the adjustment verification device. An advantage attained here is that a superimposition effect of the optical camera is avoided. In addition, the alignment of the beam that is incident to and reflected by the plane mirror is improved.

In accordance with another advantageous exemplary embodiment of the method, a yaw angle deviation of the optical camera is calculated from the deviation of the coordinates of the recorded laser image from the nominal position of the camera image in the X direction.

In accordance with another advantageous exemplary embodiment of the method, a pitch angle deviation of the optical camera is calculated from the deviation of the coordinates of the recorded laser image from the nominal position of the camera image in the Y direction.

Exemplary embodiments of the present invention are described in the following with reference to the accompanying drawings.

### BRIEF DESCRIPTION OF DRAWINGS

FIG. 1 shows a method for determining adjustment deviations of an image data capture chip of an optical camera in accordance with one exemplary embodiment of the present invention.

FIG. 2 shows an adjustment verification device for determining adjustment deviations of an image data capture chip of an optical camera in accordance with another exemplary embodiment of the present invention.

FIG. 3 shows an adjustment verification device for determining adjustment deviations of an image data capture chip of an optical camera in accordance with another exemplary embodiment of the present invention.

FIG. 4 shows an adjustment verification device for determining adjustment deviations of an image data capture chip of an optical camera in accordance with another exemplary embodiment of the present invention.

In the figures, like or functionally equivalent elements, features and components—provided that nothing else is specified—are each provided with the same reference numerals. For the sake of clarity and comprehension, it is understood that the components and elements in the drawings are not necessarily shown true-to-scale relative to one another.

### DETAILED DESCRIPTION

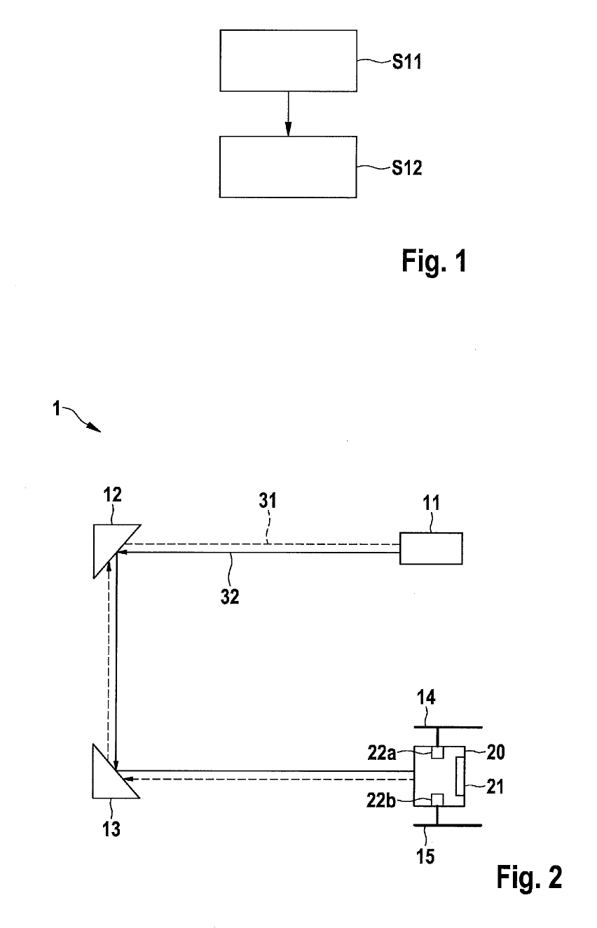

FIG. 1 shows a method for determining adjustment deviations of an image data capture chip of an optical camera in accordance with one exemplary embodiment of the present invention.

In a first step S11 of the method, a laser beam 31, 130a-c of a laser source 11, 120 is aligned by an adjustment verification device 1, 100 to a camera image to be recorded by optical camera 40, 140. The alignment is carried out, for example, relative to a mechanically precisely manufactured replica of the optical camera housing that includes a plane mirror at the sensor position. Once the laser beam is aligned, this replica is replaced by an optical camera 40, 140 having sensors, upon which a visible laser image is formed by laser beam 31, 130a-c; adjustment verification device 1, 100 has a camera holder 14, 15, 123a, 123b for the positionally correct installation of optical camera 40, 140.

In a second step S12 of the method, the camera image is recorded by positionally correctly installed optical camera 40, 140. In addition, coordinates of the laser image recorded in the camera image are defined, and a deviation in the coordinates of the recorded laser image from a nominal position of the camera image is determined, and, on the basis thereof, deviations in the adjustment of the image data capture chip of optical camera 40, 140 are derived.

Besides determining deviations in the adjustment of an image data capture chip of optical camera 40, 140, the method also makes it possible to determine deviations in the adjustment of another optical system of camera 40, 140, such as of a lens.

FIG. 2 shows an adjustment verification device for determining adjustment deviations of an image data capture chip of an optical camera in accordance with one exemplary embodiment of the present invention.

FIG. 2 shows an adjustment verification device 1 that includes a camera holder 14, 15 for a reference camera 20 that has bearing elements 22a, 22b for installing reference camera 20 in camera holder 14, 15 and a mounting surface 21 for a plane mirror. In addition, adjustment verification device 1 includes a laser source 11 that is configured in adjustment verification device 1 in a way that permits adjustment of laser beam 31 on the plane mirror at one location of an optical axis of adjustment verification device 1, and a reflected laser beam 32 to be adjusted in coincidence with laser beam 31.

The mechanical dimensions of reference camera 20, as well as the defined optical axis of adjustment verification device 1 are known from design data, for example.

The spatial configuration of an optical system and of the image capture chip of optical camera 40 are likewise defined, as is the resolution of the image capture chip in pixels. The zero point of the image plane of the optical system of optical camera 40 is assumed, for example, to be in the middle of the image sensor or image capture chip. This point is the main point of the imaging in the sense of the central projection of a pinhole camera and forms the base point of the optical axis of the system and that of the projection center.

The optical axis of adjustment verification device 1 is represented by the straight line through the main point in the image plane and the projection center, the positional angles of optical camera 40 or of reference camera 20 in relation to the projection center being indicated.

In accordance with the design data of optical camera 40, a milled camera shell or reference camera 20 is manufactured. In this context, it is a property of reference camera 20 that the plane in which the image sensor of optical camera 40 would be installed is suited for mounting a semitransparent mirror or plane mirror. The location of the image sensor should represent a symmetric cutout in the camera shell that has approximately the same dimensions as the sensor.

Moreover, this plane must have a direct relationship to the later suspension of the camera housing that is defined by bearing elements 22a, 22b.

This relationship is significant for the later positioning of optical camera 40 relative to laser beam 31 of laser source 11. The details of the relationship may only be defined in the sense of the application and the design.

A semitransparent mirror is fixedly mounted at the position of the image sensor, it being possible for an adhesion or a mechanical fixing to be used. It is to be ensured that this interface is as plane as possible.

The semitransparent mirror may be round or square, for example, and correspond approximately to the dimensions of the image sensor. The center of the semitransparent mirror must be marked so that it coincides to the greatest degree possible with the center of the sensor position when attached.

As laser source 11, an He-Ne laser having a continuous power of less than 1 mW and a beam diameter of approximately 1 mm is used, for example.

In addition, adjustment verification device 1 has at least two path-folding mirrors 12, 13 through which laser beam 31 is directed to strike reference camera 20 in camera holder 14, 15.

Laser beam 31 is adjusted with the aid of path-folding mirrors 12, 13 to be perpendicularly incident to the center of semitransparent mirror of reference camera 20. This is ensured by adjusting a reflected laser beam 32 to coincide with laser beam 31.

The optical path of laser beam 31 to reference camera 20 is selected to be as long as possible, for example, more than 3 m, to ensure that minimal inclination of laser beam 31 relative to the mirror of reference camera 20 effects a substantial deflection of reflected laser beam 32 and that the inclination is readily detectable.

In addition, aperture elements 16, 17 may be used, for example, to limit the diameter of laser beam 31 in order to facilitate detection of the inclination of laser beam 31.

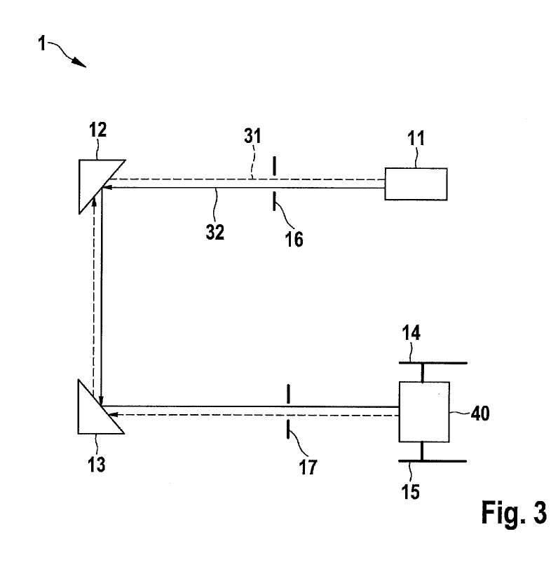

FIG. 3 shows an adjustment verification device for determining adjustment deviations of an image data capture chip of an optical camera in accordance with another exemplary embodiment of the present invention.

In FIG. 3, reference camera 20 is replaced by an optical camera 40 that is able to record a camera image. If a camera image is recorded by optical camera 40, a laser image of laser source 11 in the form of a laser spot is visible on the recorded camera image of optical camera 40.

For example, the difference between the position of the laser spot and the center of the image or other nominal position may be arithmetically determined. The yaw angle is calculated from the positional deviation of the laser spot in the X direction, and the pitch angle is calculated from the positional deviation in the Y axis. The projection center represents the pivotal point for determining both angles. This quantity may be derived from the design or a measurement.

For this, it may be necessary for the laser spot to be weakened in intensity. To this end, filter elements or aperture elements 16, 17 are used, for example. The filter elements are designed as optical filters, for example, and select the incident laser radiation in accordance with certain criteria, such as wavelength, polarization state or direction of incidence.

The diameter of the laser beam may be limited, for example, by adapting the same to the particular optical system of optical camera 40. The greater the lens coverage of the optical system of optical camera 40, the more carefully it is verified that laser beam 31 is propagating along the optical axis of adjustment verification device 1 and has a small enough diameter. This ensures that laser beam 31 strikes in the paraxial region of the optical system of optical camera 40, so that any geometric aberrations of the optical system do not have an effect.

Further reference numerals of FIG. 3 are already described with reference to FIG. 2.

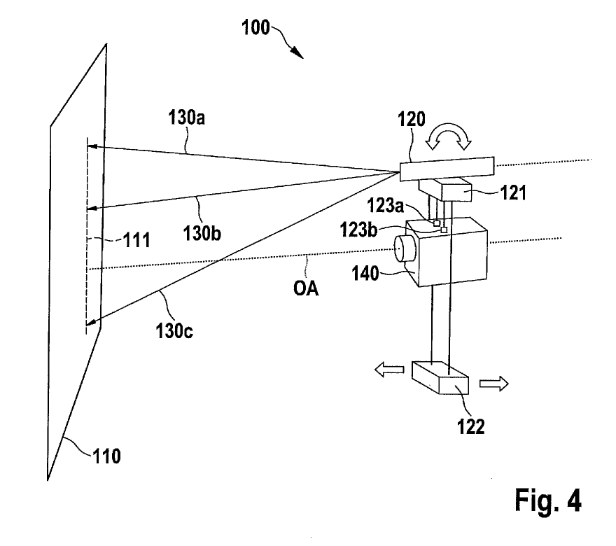

FIG. 4 shows an adjustment verification device for determining adjustment deviations of an image data capture chip of an optical camera in accordance with another exemplary embodiment of the present invention.

In this context, adjustment verification device 100 includes a projection surface 110 upon which a line 111 may be projected and for which an image may be formed by an optical camera 140, a laser source 120, that is provided for projecting line 111 on projection surface 110 that is disposed perpendicularly in front of optical axis OA of optical camera 140, and a rocker-type unit 121 that is provided for the rotational mounting of laser source 120.

In addition, adjustment verification device 100 includes fixed points of engagement in the form of a camera holder 123a, 123b for mechanically suspending optical camera 140, the position of optical camera 140 being defined in relation to optical axis OA of adjustment verification device 100. In addition, rocker unit 121 allows stationary mounting of optical camera 140 on a stand.

Laser source 120 is mounted, for example, in parallel and offset vertically, above or below optical axis OA of adjustment verification device 100.

A pendulum unit 122 allows a continuous rocking motion for rocker-type unit 121; during one oscillation cycle, laser source 120 of adjustment verification device 100 projects laser beams 130a, 130b, 130c onto projection surface 110 in a way that allows line 111 to be imaged as a laser image of laser beams 130a, 130b, 130c.

To capture a sequence of camera images, suitable software is used to operate optical camera 140. The total configuration composed of rocker-type unit 121 and optical camera 140 is set up in a way that allows laser beams 130a, 130b, 130c to be projected, for example, at a wall or plate that is approximately 5 m distant from optical camera 140.

Rocker-type unit 121 having an energized laser source 120 is set into oscillation relative to optical camera 140. During this oscillation period, optical camera 140 records a sequence of camera images. For this purpose, a darkening may be effected, for example.

In the course of the rocking motion, laser source 120 projects a line 111 at projection surface 110. The sequence of recorded camera images is later assembled in an additive process, for example, thereby producing an image of line 111.

In the case of an ideally manufactured optical camera 140 without adjustment deviations, line 111 is a perpendicular line in the image plane of the recorded camera image, line 111 extending along the middle slit of the image sensor.

An optical camera 140, which is subject to manufacturing tolerances, records a line 111, for example, that forms an angle with the horizontal of projection surface 110. This deviation of such an oblique line from an ideally normal line yields the roll angle of optical camera 140. The oblique and normal line cross each other in the center of the sensor. The roll angle is relative to this point, the point where optical axis OA pierces the image sensor.

In the manufacture of rocker-type unit 121, care is to be taken to ensure that the recording beam propagates in parallel to optical axis OA of adjustment verification device 100.

Although the present invention is described above on the basis of preferred exemplary embodiments, it is not limited thereto. Rather, it may be modified in numerous ways.

1-15. (canceled)

16. A method for determining adjustment deviations of an image data capture chip of an optical camera, comprising:
aligning a laser beam of a laser source by an adjustment verification device to a camera image which is to be recorded by the optical camera and upon which a visible laser image is formed by the laser beam, the adjustment verification device having a camera holder for positionally correct installation of the optical camera; and
recording the camera image by the positionally correctly installed optical camera, determining coordinates of the laser image recorded in the camera image, determining a deviation in the coordinates of the recorded laser image from a nominal position of the camera image, and, on a basis thereof, deriving the adjustment deviations of the image data capture chip of the optical camera.

17. The method according to claim 16, further comprising, prior to the aligning of the laser beam:
making a reference camera ready for use that has bearing elements for installing the reference camera in the camera holder of the adjustment verification device and a mounting surface for a plane mirror, and that is used as part of the adjustment verification device; and
equipping the mounting surface of the reference camera with the plane mirror and clamping the reference camera in the camera holder.

18. The method according to claim 17, wherein the alignment of the laser beam in the adjustment verification device is accomplished in that the laser beam strikes the plane mirror at one location of an optical axis of the adjustment verification device, and a reflected laser beam is reflected in coincidence with the laser beam, the reference camera being replaced by the optical camera.

19. The method according to claim 16, wherein pitch and/or yaw deviations of the image data capture chip of the optical camera are determined as deviations in the adjustment deviations of the image data capture chip of the optical camera.

20. The method according to claim 16, wherein a filter element is introduced into a ray path of the laser beam to prevent any overexposure of the optical camera.

21. The method according to claim 16, wherein aperture elements limit a diameter of the laser beam when aligning the laser beam of the laser source in the adjustment verification device.

22. The method according to claim 16, wherein a yaw angle deviation of the optical camera is calculated from the deviation of the coordinates of the recorded laser image from the nominal position of the camera image in an X direction.

23. The method according to claim 16, wherein a pitch angle deviation of the optical camera is calculated from the deviation of the coordinates of the recorded laser image from the nominal position of the camera image in a Y direction.

24. The method according to claim 16, further comprising:
prior to the aligning of the laser beam, a rocker-type unit is made ready for use that allows an oscillation of the laser source that radiates onto a projection surface that is disposed perpendicularly in front of an optical axis of the optical camera.

25. The method according to claim 24, wherein to record the camera image, a recording of an image sequence of individual images of the projection surface by the optical camera takes place during one oscillation cycle of the rocker-type unit; and to determine the deviation, the image sequence is analyzed by an image processing routine, angle deviations of the optical camera from the perpendicular being determined by a deviation of a line that is swept by the laser beam during the oscillation cycle.

26. The method according to claim 25, wherein the rocker-type unit is deflected such that a complete image height of the optical camera is swept vertically by the laser beam during the oscillation cycle.

27. The method according to claim 25, wherein the deviation from the perpendicular of the line that is swept by the laser beam corresponds to the angle deviations of the optical camera.

28. The method according to claim 25, wherein the optical camera is used for setting up testing and manufacturing devices using a correction value that is based on the ascertained adjustment deviations.

29. An adjustment verification device for determining angular deviations of an optical camera, comprising:
a camera holder for a reference camera that has bearing elements for installing the reference camera in the camera holder and a mounting surface for a plane mirror; and
a laser source that is configured in the adjustment verification device and adapted to allow a laser beam to be adjusted on the plane mirror at one location of an optical axis of the adjustment verification device, and a reflected laser beam to be adjusted in coincidence with the laser beam.

30. An adjustment verification device for determining angular deviations of an optical camera, comprising:
a projection surface, upon which a line can be projected and for which an image may be formed by the optical camera;
a laser source adapted for projecting the line on the projection surface that is disposed perpendicularly in front of an optical axis of the optical camera; and
a rocker-type unit adapted for rotational mounting of the laser source.
